(19) United States
(12) Patent Application Publication
(10) Pub. No.: US 2009/0148291 A1
(43) Pub. Date: Jun. 11, 2009

(54) MULTI-SECTION WIND TURBINE ROTOR BLADES AND WIND TURBINES INCORPORATING SAME

(75) Inventors: Brandon S. Gerber, Ware Shoals, SC (US); Stefan Herr, Greenville, SC (US); Nicholas K. Althoff, Ware Shoals, SC (US); Kevin J. Standish, Simpsonville, SC (US); Mark J. West, Hjellestad (NO)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/951,366

(22) Filed: Dec. 6, 2007

(51) Int. Cl. F03D 1/06; F01D 5/14

(52) U.S. Cl. 416/147; 416/204 R; 416/241 R

(57) ABSTRACT

A multi-section blade for a wind turbine comprising a hub extender connected to a hub of the wind turbine is provided. The blade includes at least one pitchable outboard section. The hub extender can have a pitch bearing located near the interface between the hub and hub extender, or the hub extender and outboard blade section. The hub extender can be configured to pitch or not pitch with the outboard blade sections. An aerodynamic fairing is configured to mount over the hub extender and is configured to not pitch with the outboard blade sections.

### BACKGROUND OF THE INVENTION

This invention relates to wind turbines, and more particularly to wind turbines having rotor blades built in more than one piece or section.

Recently, wind turbines have received increased attention as an environmentally safe and relatively inexpensive alternative energy source. With this growing interest, considerable efforts have been made to develop wind turbines that are reliable and efficient.

Generally, a wind turbine includes a rotor having multiple blades. The rotor is mounted within a housing or nacelle, which is positioned on top of a truss or tubular tower. Utility grade wind turbines (i.e., wind turbines designed to provide electrical power to a utility grid) can have large rotors (e.g., 30 meters or more in diameter). Blades on these rotors transform wind energy into a rotational torque or force that drives one or more generators, rotationally coupled to the rotor through a low speed shaft and/or a gearbox. The optional gearbox may be used to step up the inherently low rotational speed of the turbine rotor for the generator to efficiently convert mechanical energy to electrical energy, which is fed into a utility grid. Some turbines (i.e., direct drive) utilize generators that are directly coupled to the rotor without using a gearbox.

As the power generating capacity of wind turbines increase, the dimensions of their rotor blades and other components also increase. At some point, practical transportation and logistics limits may be exceeded. These non-technical limitations lead to constraints on the energy production ratings of on-shore wind turbines.

### BRIEF DESCRIPTION OF THE INVENTION

In one aspect, the present invention provides a multi-section blade for a wind turbine comprising a hub extender and a fairing. The hub extender is connected to the hub of the wind turbine. A pitch bearing is located near the joint between the hub and the hub extender. The hub extender is substantially fixed in relation to the blade so that the hub extender pitches with the blade. The aerodynamic fairing is configured to mount over the hub extender. At least one outboard section of the blade is configured to couple to the pitch bearing.

In another aspect, the present invention provides a multi-section blade for a wind turbine comprising a pitch bearing and at least one outboard section configured to couple to the pitch bearing. A hub extender is connected to the hub of the wind turbine. A pitch bearing is located near a joint between the hub extender and an outboard section. The hub extender is configured to not pitch with the multi-section blade. An aerodynamic fairing is configured to mount over the hub extender.

### BRIEF DESCRIPTION OF THE DRAWINGS

FIG. 1 is an illustration of an exemplary configuration of a wind turbine configuration of the present invention.

FIG. 2 is an illustration of a partial, perspective view of a rotor and nacelle of the wind turbine configuration of FIG. 1.

FIG. 3 is an illustration of a partial, perspective view of a rotor and nacelle of the wind turbine configuration of FIG. 1 showing the blades in a feathered state.

FIG. 4 is an illustration of a partial, perspective view of a rotor and nacelle of the wind turbine wherein the blades have an alternative fairing and hub extender configuration.

### DETAILED DESCRIPTION OF THE INVENTION

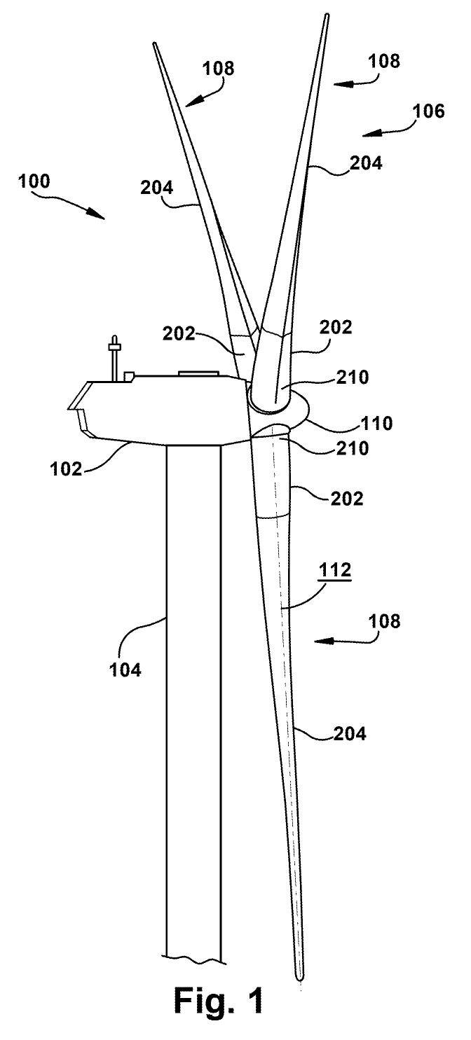

In some configurations and referring to FIG. 1, a wind turbine 100 comprises a nacelle 102 housing a generator (not shown in FIG. 1). Nacelle 102 is mounted atop a tall tower 104, only a portion of which is shown in FIG. 1. Wind turbine 100 also comprises a rotor 106 that includes a plurality of rotor blades 108 attached to a rotating hub 110. Although wind turbine 100 illustrated in FIG. 1 includes three rotor blades 108, there are no specific limits on the number of rotor blades 108 required by the present invention.

Various components of wind turbine 100 in the illustrated configuration are housed in nacelle 102 atop tower 104 of wind turbine 100. The height of tower 104 is selected based upon factors and conditions known in the art. In some configurations, one or more microcontrollers comprising a control system are used for overall system monitoring and control including pitch and speed regulation, high-speed shaft and yaw brake application, yaw and pump motor application and fault monitoring. Alternative distributed or centralized control architectures can be used in some configurations. The pitches of blades 108 can be controlled individually in some configurations, such that portions of each blade 108 are configured to rotate about a respective pitch axis 112. The pitch axis 112 is substantially parallel to the span of blade 108. Hub 110 and blades 108 together comprise wind turbine rotor 106. Rotation of rotor 106 causes a generator (not shown in the figures) to produce electrical power.

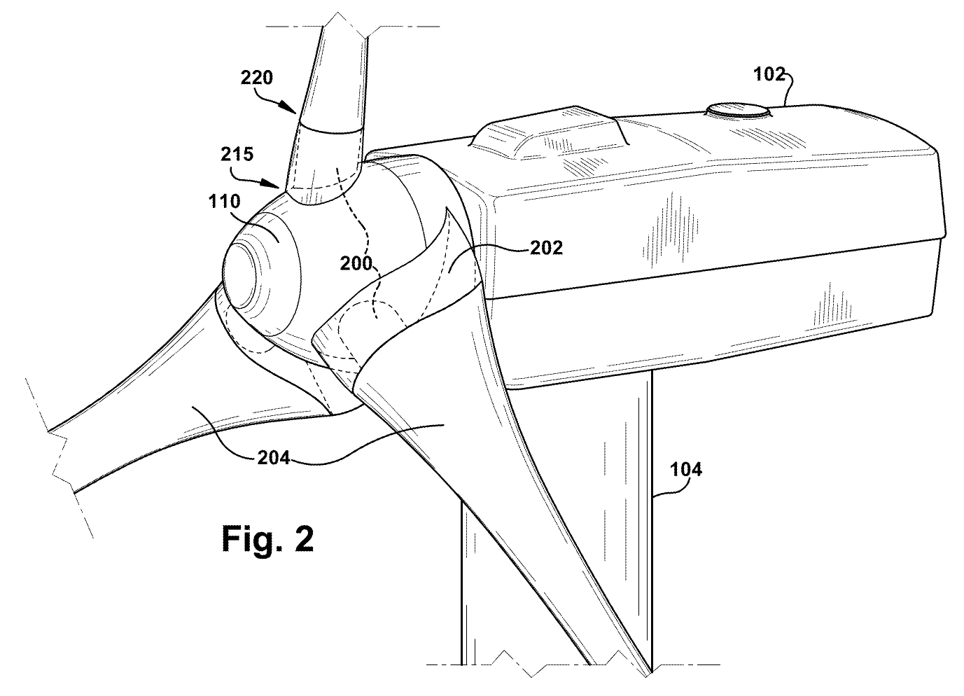

In some configurations of the present invention and referring to FIGS. 1 and 2, blades 108 can comprise a plurality of sections that can be separately shipped, have multiple sections shipped in one container or manufactured on-site to facilitate transportation and/or take advantage of differences in the way inboard sections and outboard sections can be manufactured.

For example, some configurations of blades 108 comprise three sections, namely, a hub extender 200, an aerodynamic fairing 202, and an outboard section 204. In some embodiments outboard section 204 will comprise a plurality of outboard sections. For example, the outboard section 204 could be comprised of six individual sections that can be joined to form one overall outboard blade section. In some configurations, blade 108 is divided at a selected distance (e.g., from about 5% to about 40%) from blade root 210. In these configurations, skirt or fairing 202 comprises from about 5% to about 40% of the length of an assembled blade 108 from blade root 210, and outboard section 204 comprises the remaining length. A more preferred range that blade 108 could be divided at a selected distance is about 5% to about 30%. Fairing 202 fits or mounts over hub extender 200 fixedly (so as not to rotate or move with respect to outboard section 204) in some configurations, or is mechanically coupled to hub 110 (e.g., by gluing, bolting, attachment to a frame, or otherwise affixing the fairing thereto). In other embodiments fairing 202 could be attached to or manufactured as part of the nose cone of hub 110.

Hub extender 200 can be affixed to hub 110 and may have a pitch bearing at either end. The hub extender 200 could be fabricated of any suitable material including, but not limited to aluminum, metal alloys, glass composites, carbon composites or carbon fiber. The hub extender could be substantially at least one, or combinations, of cylindrical, oval, conical, or frusto-conical in shape. In one embodiment, hub extender 200 pitches with blade section 204 and a pitch bearing could be located at the interface between the hub 110 and the hub extender 200. This location of the pitch bearing is indicated by arrow 215 in FIG. 2. In other embodiments, hub extender could be configured so that it does not pitch with blade section 204. The hub extender would be stationary with respect to the pitching blade section 204, and the pitch bearing could be located at the interface between the outboard blade section 204 and the hub extender 200. This alternate location of the pitch bearing is indicated by arrow 220 in FIG. 2.

There are advantages to locating the pitch bearing away from hub 110. As the pitch bearing is moved radially outward along blade 108, the loads experienced by the pitch bearing are decreased. For example, the pitch bearing could be located radially outward along blade 108 at a distance of about 30% of the blade span. This location reduces the weight of the blade section supported by the pitch bearing, and the bending moments at the pitch bearing are also reduced. A smaller pitch bearing can be used at this location resulting in lower costs and reduced weight. Another advantage is that a smaller pitch motor could be employed in the pitch system, due to the fact that a smaller mass needs to be driven. The smaller mass also allows for a faster response time for the overall pitch system. A faster response allows the blades to be pitched more rapidly to respond to changing wind conditions. Another result of this faster response time is improved energy capture.

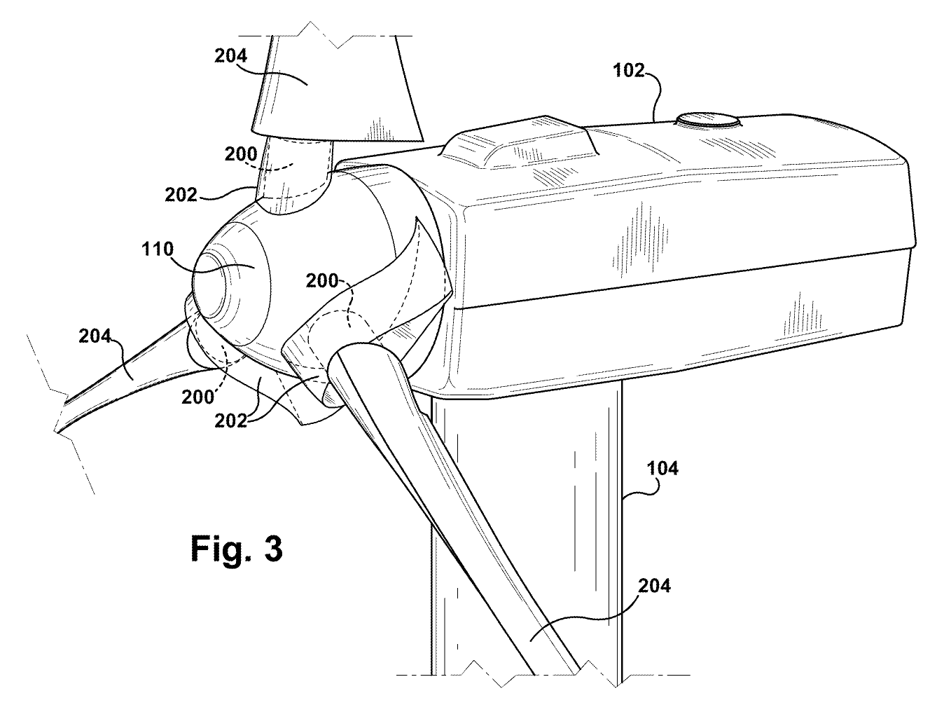

FIG. 3 illustrates a wind turbine with the blade sections 204 in a feathered configuration. The blades sections 204 can be pitched or rotated in increments (e.g., one degree increments from 0 to 90 degrees). A 90 degree pitch could be used to idle or stall the rotor. When the blade sections 204 are pitched to 90 degrees, the lift provided by the wind is reduced to a point insufficient to turn the rotor. This feathered state can be used when the wind turbine needs maintenance or during excessively high wind conditions.

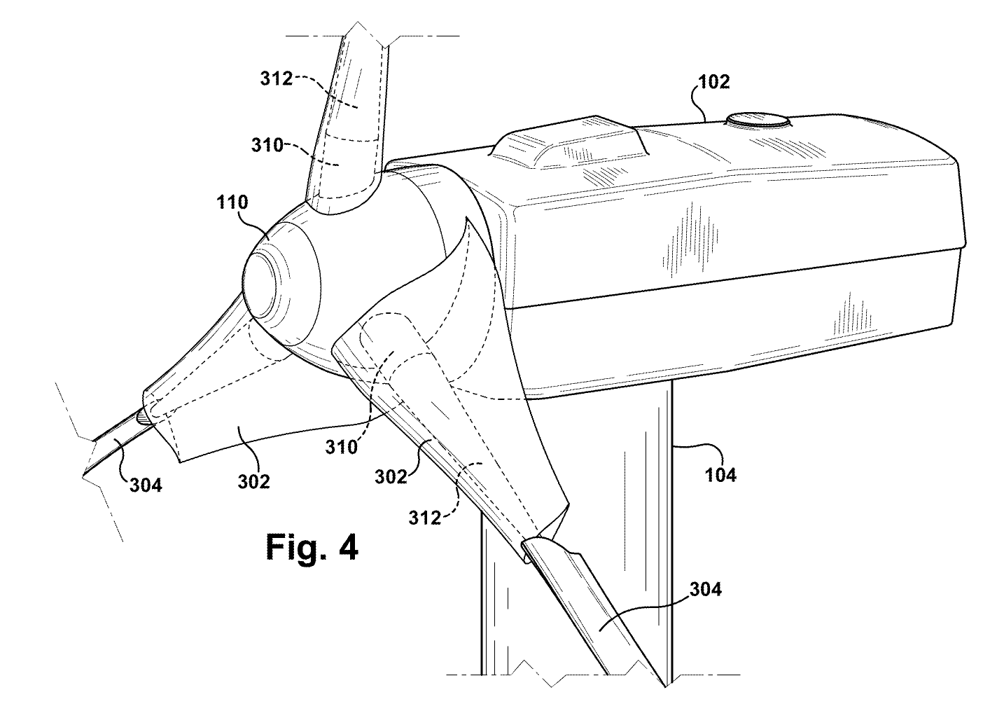

FIG. 4 illustrates another embodiment of the present invention. This example shows the use a longer fairing 302, which could be 30% to 40% of the overall blade span. The hub extender could be comprised of two sections, a first hub extender 310 and a second hub extender 312. The first and second hub extenders can be substantially at least one, or combinations, of cylindrical, oval, conical, or frusto-conical in shape. The first and second hub extender could be fabricated of any suitable material including, but not limited to aluminum, metal alloys, glass composites, carbon composites or carbon fiber. As one example, the first hub extender could be generally cylindrical in cross-section and it is connected to a second hub extender that may be generally conical or frusto-conical in cross section. The fairing 302 mounts over the first and second hub extenders and can be fixedly attached to hub 110.

The fairings 202 and 302, previously described, can be aerodynamically shaped to improve energy capture of the wind turbine 100. In previous designs, the section of the blade that made connection with the hub 110 was of generally cylindrical shape, and this cylindrical shape facilitated connection to the hub and the use of a pitch bearing at the interface between the hub and blade. However, this cylindrically shaped blade portion was very inefficient from an aerodynamic, lift-producing, perspective.

The fairings proposed by embodiments of the present invention are designed to provide lift and extend the working area of the blades 108. This extended working area provides for increased energy capture and improved efficiency. Another advantage is that the hub losses (as experienced by prior designs) can be reduced, because the stall typically seen in the root region is reduced. The flow stream of the wind around the nacelle is also improved due to the aerodynamic shape of the fairings. The improved flow stream may improve the accuracy of nacelle mounted anemometers and other wind measuring devices.

During periods of very high wind speeds (e.g., during storms) the blades are typically pitched to feather. In previous blade designs, the entire blade was pitched and this sometimes resulted in very large loads experienced by the blade and the pitch bearings. As proposed by embodiments of the present invention, a reduced blade area is pitched and the remaining blade portion comprised of the aerodynamic fairing remains fixed, or un-pitched. The un-pitched blade section (i.e., the fairing) experiences lower storm loads and helps divert portions of the high winds around the nacelle. As provided by aspects of the present invention, the rotor experiences reduced storm loads while the outboard blade sections (pitched to feather) are aerodynamically inefficient and prevent the rotor from turning.

Blade sections 200, 202, 204, 302, 310, 312 can be constructed using carbon fiber and/or other construction material. In some configurations in which it is used, an extra economy is achieved by limiting the use of carbon fiber to outer parts (i.e., those portions exposed to the elements) of rotor blades 108, where the carbon fibers provide maximum static moment reduction per pound. This limitation also avoids complex transitions between carbon and glass in rotor blades and allows individual spar cap lengths to be shorter than would otherwise be necessary. Fabrication quality can also be enhanced by this restriction. Another advantage of multiple piece blades 108 is that different options can be used or experimented with during the development or life of a rotor 106.

While the invention has been described in terms of various specific embodiments, those skilled in the art will recognize that the invention can be practiced with modification within the spirit and scope of the claims.

What is claimed is:

1. A multi-section blade for a wind turbine comprising:
a hub extender connected to a hub of said wind turbine, said hub extender having a pitch bearing located near a joint between a hub of said wind turbine and said hub extender, said hub extender being configured so that said hub extender pitches with said blade;
an aerodynamic fairing having a hole therein and configured to mount over said hub extender; and
at least one outboard section configured to couple to said pitch bearing.

2. The multi-section blade according to claim 1, wherein said hub extender is substantially at least one, or combinations, of cylindrical, oval, conical, or frusto-conical in shape.

3. The multi-section blade according to claim 1, wherein said hub extender is comprised of at least one of two sections, a first section substantially cylindrical in shape and a second section substantially conical or frusto-conical in shape.

4. The multi-section blade according to claim 1, wherein said hub extender comprises at least one of a composite or metallic material.

5. The multi-section blade according to claim 1, wherein said hub extender comprises an integral part of said at least one outboard section.

6. The multi-section blade according to claim 1, wherein said hub extender comprises a distinct part and separate from said at least one outboard section.

7. The multi-section blade according to claim 1, wherein said aerodynamic fairing is comprised of a composite material.

8. The multi-section blade according to claim 1, wherein said aerodynamic fairing is configured to be substantially fixed in relation to said at least one outboard section so that when said at least one outboard section is pitched, said aerodynamic fairing remains fixed with respect to said at least one outboard section.

9. The multi-section blade according to claim 1, wherein said aerodynamic fairing comprises an integral part of said hub or a nosecone of said wind turbine.

10. The multi-section blade according to claim 1, wherein said aerodynamic fairing comprises from about 5% to about 30% of the length or span of an assembled blade.

11. A multi-section blade for a wind turbine comprising:
a pitch bearing;
at least one outboard section configured to couple to said pitch bearing; said at least one outboard blade section being configured to be movable about a pitch axis:
a hub extender connected to a hub of said wind turbine, said hub extender having said pitch bearing located near a joint between said hub extender and said at least one outboard section, wherein said hub extender is configured to remain fixed with respect to said at least one outboard section; and
an aerodynamic fairing configured to mount over said hub extender.

12. The multi-section blade according to claim 11, wherein said hub extender is substantially at least one, or combinations, of cylindrical, oval, conical, or frusto-conical in shape.

13. The multi-section blade according to claim 11, wherein said hub extender is comprised of at least one of two sections, a first section substantially cylindrical in shape and a second section substantially conical or frusto-conical in shape.

14. The multi-section blade according to claim 11, wherein said hub extender comprises a composite or metallic material.

15. The multi-section blade according to claim 11, wherein said hub extender comprises an integral part of said hub.

16. The multi-section blade according to claim 11, wherein said hub extender comprises a distinct part of said hub.

17. The multi-section blade according to claim 11, wherein said aerodynamic fairing is comprised of a composite material.

18. The multi-section blade according to claim 11, wherein said aerodynamic fairing is configured to be substantially fixed in relation to said at least one outboard section so that when said at least one outboard section is pitched, said aerodynamic fairing remains fixed with respect to said at least one outboard section.

19. The multi-section blade according to claim 11, wherein said aerodynamic fairing comprises an integral part of said hub or a nosecone of said wind turbine.

20. The multi-section blade according to claim 11, wherein said aerodynamic fairing comprises from about 5% to about 30% of the length or span of an assembled blade.
